(19) United States
(12) Patent Application Publication
(10) Pub. No.: US 2022/0101829 A1
(43) Pub. Date: Mar. 31, 2022

(54) NEURAL NETWORK SPEECH RECOGNITION SYSTEM

(71) Applicant: HARMAN INTERNATIONAL INDUSTRIES, INCORPORATED, Stamford, CT (US)

(72) Inventors: Nitya TANDON, Uttar Pradesh (IN); Arindam DASGUPTA, West Bengal (IN)

(21) Appl. No.: 17/487,508

(22) Filed: Sep. 28, 2021

Related U.S. Application Data
(60) Provisional application No. 63/084,738, filed on Sep. 29, 2020.

(51) Int. Cl. G10L 15/08; G10L 15/00

(52) U.S. Cl. CPC G10L 15/08; G10L 2015/088; G10L 15/005

(57) ABSTRACT

A voice recognition system for an infotainment device may include a microphone configured to receive an audio command from a user, the audio command including at least one word in a first language and at least one word in a second language, and a processor configured to kg receive a microphone input signal from the microphone based on the received audio command, assign an attention weight to each word in the input signal, the attention weight indicating an importance of each word relative to another word and determine an intent of the audio command using the attention weights of all of the words.

### CROSS-REFERENCE TO RELATED APPLICATIONS

This application claims the benefit of U.S. provisional application Ser. No. 63/084,738 filed Sep. 29, 2020, the disclosure of which is hereby incorporated in its entirety by reference herein.

### TECHNICAL FIELD

Disclosed herein are systems relating to the speech recognition using neural networks.

### BACKGROUND

Voice agent devices and infotainment systems may include voice controlled personal assistants that implement artificial intelligence based on user audio commands. Some examples of voice agent devices may include Amazon Echo, Amazon Dot, Google At Home, etc. Such voice agents may use voice commands as the main interface with processors of the same. The audio commands may be received at a microphone within the device. The audio commands may then be transmitted to the processor for implementation of the command.

### SUMMARY

A voice recognition system for an infotainment device may include a microphone configured to receive an audio command from a user, the audio command including at least one word in a first language and at least one word in a second language, and a processor configured to receive a microphone input signal from the microphone based on the received audio command, assign an attention weight to each word in the input signal, the attention weight indicating an importance of each word relative to another word and determine an intent of the audio command using the attention weights of all of the words.

A method for performing voice recognition system for an infotainment device, the computer-program product comprising instructions for receiving a microphone input signal including an audio command, identifying a plurality of input words within the audio command, assigning an attention weight to each input word in the audio command, the attention weight indicating an importance of each word relative to another word, and determining an intent of the audio command using the attention weights of all of the words.

A computer-program product embodied in a non-transitory computer readable medium that is programmed for performing voice recognition system for an infotainment device, the computer-program product comprising instructions for receiving a microphone input signal including an audio command, identifying a plurality of input words within the audio command, assigning an attention weight to each input word in the audio command, the attention weight indicating an importance of each word relative to another word, and determining an intent of the audio command using the attention weights of all of the words.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompanying drawings in which:

FIG. 1 illustrates a system including an example infotainment device, in accordance with one or more embodiments;

FIG. 2 illustrates an example encoder-decoder model for a text-to-intent mapping of the system; and

FIG. 3 illustrates a block diagram of the infotainment system.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Persons who speak more than one language may tend to mix their native language with other languages that they regularly converse in. This may be known as code-mixing or code-switching. In one example, a user may say “Gaana play karo.” The Hindi words “gaana” and “karo,” translate to mean “song” and “do”, respectively. The English word “play” is spoken between the two Hindi words. Existing infotainment devices, including Google Assistant or Alexa, may process speech input in only one language and tend to give incorrect answers or commands, or fail to give any response or answer. Thus, the dual language command becomes a bottleneck for the current systems for users who are not fluent in a single language or use code-mixed commands.

Disclosed herein is a speech recognition system for infotainment devices such as personal assistant devices capable of accurately processing code-mixed commands. The system may infer the meaning of a code mixed audio command given by a user using an attention neural network that applies attention weights to each of the words of the command to quickly and accurately determine the intent of the command even when multiple languages are mixed into the command.

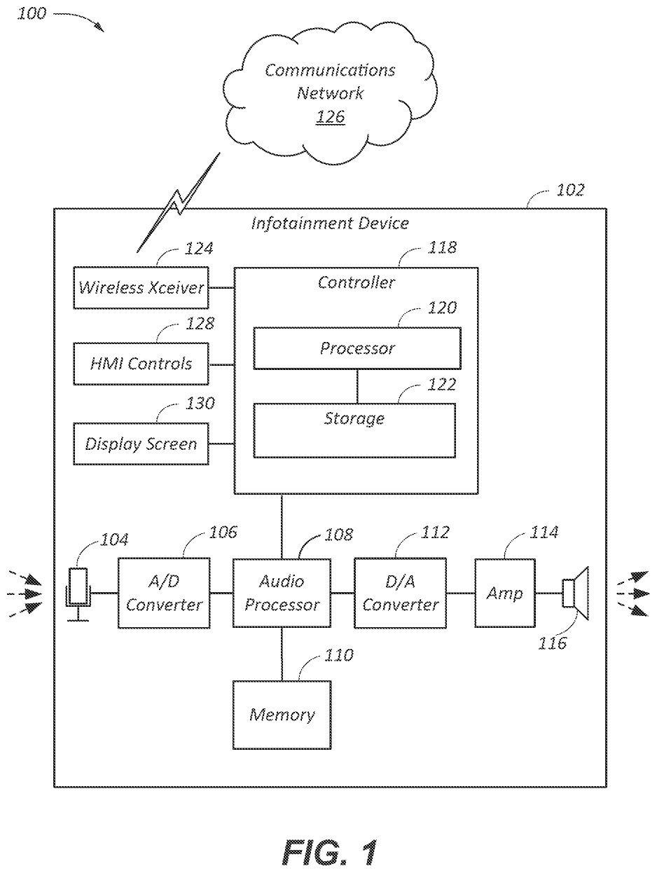

FIG. 1 illustrates a system 100 including an example infotainment device 102, such as and also referred to herein as an intelligent personal assistant device 102. The device 102 may receive audio through a microphone 104 or other audio input, and passes the audio through an analog to digital (A/D) converter 106 to be identified or otherwise processed by an audio processor 108. The audio processor 108 also generates speech or other audio output, which may be passed through a digital to analog (D/A) converter 112 and amplifier 114 for reproduction by one or more loudspeakers 116. The personal assistant device 102 also includes a device controller 118 connected to the audio processor 108.

The device controller 118 also interfaces with a wireless transceiver 124 to facilitate communication of the personal assistant device 102 with a communications network 126 over a wireless network. The personal assistant device 102 may also communicate with other devices, including other personal assistant devices 102 over the wireless network as well. In many examples, the device controller 118 also is connected to one or more Human Machine Interface (HMI) controls 128 to receive user input, as well as a display screen 130 to provide visual output. It should be noted that the illustrated system 100 is merely an example, and more, fewer, and/or differently located elements may be used.

The A/D converter 106 receives audio input signals from the microphone 104. The A/D converter 106 converts the received signals from an analog format into a digital signal in a digital format for further processing by the audio processor 108.

While only one is shown, one or more audio processors 108 may be included in the infotainment device 102. The audio processors 108 may be one or more computing devices capable of processing audio and/or video signals, such as a computer processor, microprocessor, a digital signal processor, or any other device, series of devices or other mechanisms capable of performing logical operations. The audio processors 108 may operate in association with a memory 110 to execute instructions stored in the memory 110. The instructions may be in the form of software, firmware, computer code, or some combination thereof, and when executed by the audio processors 108 may provide the audio recognition and audio generation functionality of the personal assistant device 102. The instructions may further provide for audio cleanup (e.g., noise reduction, filtering, etc.) prior to the recognition processing of the received audio. The memory 110 may be any form of one or more data storage devices, such as volatile memory, non-volatile memory, electronic memory, magnetic memory, optical memory, or any other form of data storage device.

In addition to instructions, operational parameters and data may also be stored in the memory 110, such as a phonemic vocabulary for the creation of speech from textual data. For example, the memory 110 may maintain look up tables of various words in a plurality of languages that invoke an action, such as “play.” The memory 110 maintain data used to determine the hidden states and weights described herein. The memory 110 may be adaptable and continuously updated based on user commands, user responses to those commands, new databases, updated languages, dictionaries, etc. Moreover, the memory 110 in combination with the processor 108, may be configured to provide machine learnable processing to continually improve the system and method described herein. The audio processor 108 is described in further detail below.

The D/A converter 112 receives the digital output signal from the audio processor 108 and converts it from a digital format to an output signal in an analog format. The output signal may then be made available for use by the amplifier 114 or other analog components for further processing.

The amplifier 114 may be any circuit or standalone device that receives audio input signals of relatively small magnitude, and outputs similar audio signals of relatively larger magnitude. Audio input signals may be received by the amplifier 114 and output on one or more connections to the loudspeakers 116. In addition to amplification of the amplitude of the audio signals, the amplifier 114 may also include signal processing capability to shift phase, adjust frequency equalization, adjust delay or perform any other form of manipulation or adjustment of the audio signals in preparation for being provided to the loudspeakers 116. For instance, the loudspeakers 116 can be the primary medium of instruction when the device 102 has no display screen 130 or the user desires interaction that does not involve looking at the device. The signal processing functionality may additionally or alternately occur within the domain of the audio processor 108. Also, the amplifier 114 may include capability to adjust volume, balance and/or fade of the audio signals provided to the loudspeakers 116.

In an alternative example, the amplifier 114 may be omitted, such as when the loudspeakers 116 are in the form of a set of headphones, or when the audio output channels serve as the inputs to another audio device, such as an audio storage device or a further audio processor device. In still other examples, the loudspeakers 116 may include the amplifier 114, such that the loudspeakers 116 are self-powered.

The loudspeakers 116 may be of various sizes and may operate over various ranges of frequencies. Each of the loudspeakers 116 may include a single transducer, or in other cases multiple transducers. The loudspeakers 116 may also be operated in different frequency ranges such as a subwoofer, a woofer, a midrange and a tweeter. Multiple loudspeakers 116 may be included in the personal assistant device 102.

The device controller 118 may include various types of computing apparatus in support of performance of the functions of the personal assist device 102 described herein. In an example, the device controller 118 may include one or more processors 120 configured to execute computer instructions, and a storage medium 122 (or storage 122) on which the computer-executable instructions and/or data may be maintained. A computer-readable storage medium (also referred to as a processor-readable medium or storage 122) includes any non-transitory (e.g., tangible) medium that participates in providing data (e.g., instructions) that may be read by a computer (e.g., by the processor(s) 120). In general, a processor 120 receives instructions and/or data, e.g., from the storage 122, etc., to a memory and executes the instructions using the data, thereby performing one or more processes, including one or more of the processes described herein. Computer-executable instructions may be compiled or interpreted from computer programs created using a variety of programming languages and/or technologies including, without limitation, and either alone or in combination, Java, C, C++, C#, Assembly, Fortran, Pascal, Visual Basic, Python, Java Script, Perl, PL/SQL, etc.

While the processes and methods described herein are described as being performed by the processor 120 and/or audio processor 108, the processor(s) may be located within a cloud, another server, another one of the devices 102, etc.

As shown, the device controller 118 may include a wireless transceiver 124 or other network hardware configured to facilitate communication between the device controller 118 and other networked devices over the communications network 126. As one possibility, the wireless transceiver 124 may be a cellular network transceiver configured to communicate data over a cellular telephone network. As another possibility, the wireless transceiver 124 may be a Wi-Fi transceiver configured to connect to a local-area wireless network to access the communications network 126.

The device controller 118 may receive input from human machine interface (HMI) controls 128 to provide for user interaction with personal assistant device 102. For instance, the device controller 118 may interface with one or more buttons or other HMI controls 128 configured to invoke functions of the device controller 118. The device controller 118 may also drive or otherwise communicate with one or more displays 130 configured to provide visual output to users, e.g., by way of a video controller. In some cases, the display 130 (also referred to herein as the display screen 130) may be a touch screen further configured to receive user touch input via the video controller, while in other cases the display 130 may be a display only, without touch input capabilities.

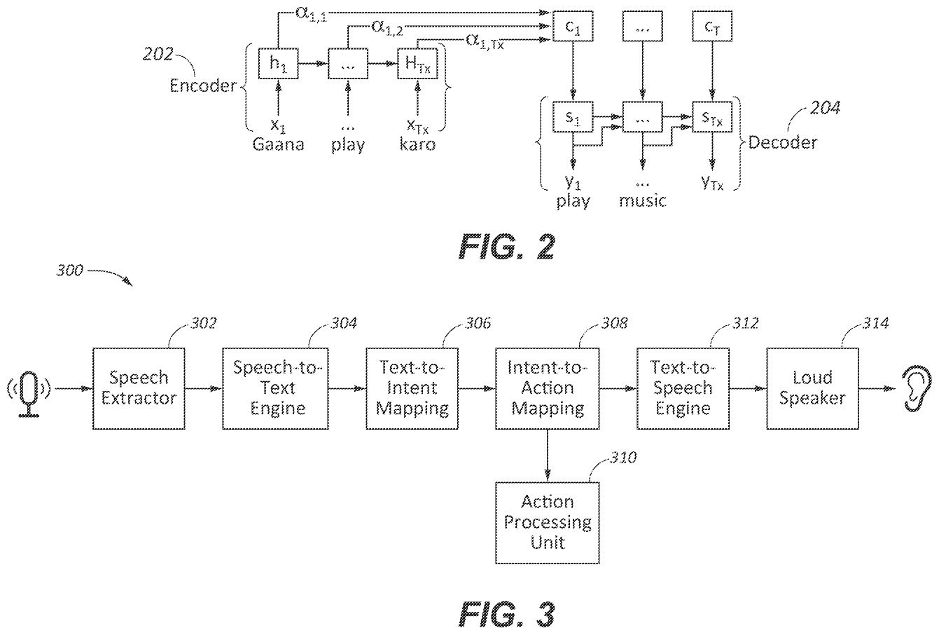

FIG. 2 illustrates an example encoder-decoder model for a text-to-intent mapping for the system 100. The audio processor 108 may form an encoder 202 and decoder 204, but other processors and controllers may also perform such functions. The microphone 104 may receive speech input, convert this speech input to text and infer a meaning of the text. Once the meaning of the text is determined, the processor 108 may proceed to address the commands, if any, inferred from the text. In order to do this, an Attention Neural Network may be used to recognize the important information from the audio input. The Attention Neural Network may aid the text-to-intent mapping so as to facilitate the natural language processing (NLP).

The encoder 202 may parse each audibly received word to create a series of hidden states h₁, h₂, hₜₓ. Each hidden state may be a floating point number and may make up a portion of a concentration of embeddings in an audible command. The hidden states h₁, h₂, hₜₓ may be determined based on the audible command as well as data stored within the memory 110.

A context vector c₁, c₂, c_{T} may be a weighted combination of the hidden states h₁, h₂, hₜₓ. Each hidden state h₁, h₂, hₜₓ contributes to a context vector with some weight. This weight is then summed to achieve a context vector for each target word. That is, these vectors c₁, c₂, c_{T} may also form a matrix of words. The encoder 202 may encode each word into hidden states h₁, h₂, hₜₓ and then produce the context vector c₁, c₂, c_{T} for each target word (T). Each target word may be a weighted concatenation of the hidden states h₁, h₂, hₜₓ of the input words.

These weights, or alphas, known as attention weights αₜₛ, may indicate the importance of the target word, or input word. For example, an action word such as “play,” may have a higher weight than a non-action word. The attention weights αₜₛ may decide the next state of the decoder as well as generate an output word. Thus, the hidden states h₁, h₂, hₜₓ of the decoder may be established using the context vector, the previous hidden state, and the previous output.

The attention weights may be determined using:

$${α}_{ts} = \frac{exp ( score ( {h}_{t} , {\overline{h}}_{s} ) )}{{\sum }_{{s}^{′} = 1}^{S} exp ( score ( {h}_{t} , {\overline{h}}_{{s}^{′}} ) )}$$

The context vector may be determining using:

$${c}_{t} = {\sum }_{s} {α}_{ts} {\overline{h}}_{s}$$

The attention vector may be determined using:

sₜ=f(cₜ,hₜ)=tan h(W_{c}[cₜ;hₜ])

Where:

αₜₛ is the attention weight for target word t and source word s,

cₜ is the context vector for target word t, and

sₜ is the attention vector for target word t.

In taking the example “Gaana play karo,” the attention weight may produce a higher weight for the word “play,” while learning the intent to “play music” during the training phase, thus giving the indication that something or some content is to be played. When another text of the same content is presented to the system at a later time, such as “play canción,” where “canción” is a Spanish word for song, the processor would again give more weight to the word “play”.

FIG. 3 illustrates a block diagram of a larger scale personal assistant system 300 of the infotainment device 102. This system 300 may include a speech extractor 302 similar to the microphone 104 of FIG. 1 where speech is recorded and extracted by the microphone. A speech-to-text (STT) engine 304 may take speech as an input and generate corresponding text output. Since the speech input may be in a code-mixed language, the output of the STT may be a code-mixed output text with words transliterated in a single language.

A text-to-intent block 306 may encompass the functions described above with respect to FIG. 2. In this block, the transliterated code-mixed text may be divided into input words. These words may be given weights, which aid in establishing the intent of the text as a whole. The text-to-intent block 306 may output a text command in English script.

For example, the phrase “Gaana play karo” may be divided into input words “Gaana”, “play”, and “karo.” Each of these input words may be given a weight. For example, the word “play” may be given a high weight, such as 10, while the words “Gaana” and “karo” may be given lesser weights, such as 3. The words may be divided via certain voice recognition algorithms and may detect breaks in the spoken acoustic phrase to identify the input words.

An intent-to-action block 308 may process the inferred intent from the text command based on stored rules within the memory 110. The memory 110 may maintain a data base of “action words” or regularly used words in order to identify and assign a weight given to each of the input words. The intent-to-action block 308 may generate action output for an action processing block 310. The action output may be determined based on a look-up table within the memory 110 of certain actions derived from the input words. These actions may include play, tune, volume, etc. The intent of the command may define the action requested by the user via the audible command. That is, the intent may be to play a certain song, or adjust the volume in a certain way.

The action processing block 310 may process the action identified by the intent-to-action block 308. Such processing may include readying certain components related to the action, such as the loudspeaker 116. The action processing block 310 may forward the generated action to the functional unit responsible for executing the task. For example, if the task is to play certain music content, the functional unit may be the processor 108 which in turn commands the amplifier 114.

The action output may also be also transmitted to a text-to-speech engine 312 which may be indicated to the user that the command is being processed. This indication may be audible, visual, haptic, etc., and may indicate to the user that the command was heard and is in the process of being carried out.

A loudspeaker 314 may receive an output signal from the engine 312 to emit audio playback in response to the received input command. As explained, the output may be an answer to a question posted by the user in the input signal, or to play a certain song, etc. That is, the true intent of the audio command is carried out, regardless of the language, or mixed language, used in the command.

Accordingly, described herein is a system for voice recognition that is capable of handling code-mixed audible commands from a user. This system may remove the dependency of knowing a particular language and only speaking commands in a single language. The neural network proposed for text-to-intent can be trained for any number of languages, any number of times, such that systems having this block would become usable globally by all the people across the world. By identifying each word in the command and assigning a context vector or weight to each word, the system may efficiently process commands to increase user satisfaction.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable.

The flowcharts and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A voice recognition system for an infotainment device, comprising:
a microphone configured to receive an audio command from a user, the audio command including at least one word in a first language and at least one word in a second language;
a processor configured to:
receive a microphone input signal from the microphone based on the received audio command;
assign an attention weight to each word in the input signal, the attention weight indicating an importance of each word relative to another word; and
determine an intent of the audio command using the attention weights of all of the words.

2. The system of claim 1, further comprising a memory configured to maintain phonemic vocabulary words in at least one of the first language and second language.

3. The system of claim 1, wherein the attention weight assigned to each word is used to generate a context vector for each word and each context vector of an audio command is used to generate a matrix of context vectors.

4. The system of claim 3, wherein the intent of the audio command is determined at least in part by determining an attention vector based on at least the context vector.

5. The system of claim 1, wherein the word with the highest attention weight is in the first language and at least one other word in the command is in the second language.

6. The system of claim 5, wherein the processor is programmed to transmit an output signal based on the determined intent of the audio command.

7. The system of claim 1, wherein the processor is configured to identify each word in the audio command.

8. A method for a voice recognition system for an infotainment device, comprising:
receiving a microphone input signal including an audio command;
identifying a plurality of input words within the audio command, the words including at least one word in a first language and at least one word in a second language;
assigning an attention weight to each input word in the audio command, the attention weight indicating an importance of each word relative to another word; and
determining an intent of the audio command using the attention weights of all of the words.

9. The method of claim 8, further comprising maintaining a phonemic vocabulary words in at least one of the first language and second language.

10. The method of claim 8, further comprising generating a context vector for each word of the audio command.

11. The method of claim 10, further comprising generating a matrix of context vectors including each context vector of the audio command.

12. The method of claim 11, wherein the intent of the audio command is determined at least in part by determining an attention vector based on at least the context vector.

13. The method of claim 8, wherein the word with the highest attention weight is in the first language and at least one other word in the command is in the second language.

14. The method of claim 13, further comprising transmitting an output signal based on the determined intent of the audio command.

15. A computer-program product embodied in a non-transitory computer readable medium that is programmed for performing voice recognition system for an infotainment device, the computer-program product comprising instructions for:
receiving a microphone input signal including an audio command;
identifying a plurality of input words within the audio command, the words including at least one word in a first language and at least one word in a second language;
assigning an attention weight to each input word in the audio command, the attention weight indicating an importance of each word relative to another word; and
determining an intent of the audio command using the attention weights of all of the words.

16. The computer-program product of claim 15, further comprising maintaining a phonemic vocabulary words in at least one of the first language and second language.

17. The computer-program product of claim 15, further comprising generating a context vector for each word of the audio command.

18. The computer-program product of claim 17, further comprising generating a matrix of context vectors including each context vector of the audio command.

19. The computer-program product of claim 18, wherein the intent of the audio command is determined at least in part by determining an attention vector based on at least the context vector.

20. The computer-program product of claim 15, wherein the word with the highest attention weight is in the first language and at least one other word in the command is in the second language.
